(19) United States
(12) Patent Application Publication
(10) Pub. No.: US 2025/0055884 A1
(43) Pub. Date: Feb. 13, 2025

(54) AUTHENTICATION OF A TERMINAL ENTITY AND A MOVABLE NETWORK ENTITY

(71) Applicant: Nokia Technologies Oy, Espoo (FI)

(72) Inventors: Divya G NAIR, Bangalore (IN); Ranganathan MAVUREDDI DHANASEKARAN, Munich (DE); Saurabh KHARE, Bangalore (IN); Stawros ORKOPOULOS, Munich (DE); German PEINADO GOMEZ, Wroclaw (PL)

(21) Appl. No.: 18/773,669

(22) Filed: Jul. 16, 2024

(30) Foreign Application Priority Data
Aug. 7, 2023 (IN) 202311052818

(51) Int. Cl. H04L 9/40; H04L 9/08

(52) U.S. Cl. CPC H04L 63/20; H04L 9/085

(57) ABSTRACT

There are provided methods, apparatuses and computer program products for authentication between a movable network entity and a terminal entity. Such provided methods, apparatuses and computer program products may include authentication and/or identification based on sending and/or receiving at least one security parameter and/or at least one authentifier.

### TECHNICAL FIELD

Embodiments of the present application relate to apparatuses and/or methods for authentication of a terminal entity and a movable network entity.

### BACKGROUND

The present disclosure generally relates to apparatuses and/or methods for authentication comprising at least one movable network entity and a terminal entity. An example of such moveable network entity may be a satellite as deployed in non-terrestrial networks, NTN.

### Example Communication System

In various communication systems, at least one moveable network entity is deployed. An example for a moveable network entity may be a non-terrestrial base station, e.g. a base station and/or next generation NodeB gNB provided on a satellite. Insofar, a corresponding entity provided on a satellite provides (full) gNB functionality, i.e. the satellite includes e.g. a gNB as an entity, which supports all required Radio Network Layer (RNL) protocols.

Alternatively, a moveable network entity is not restricted to a gNB provided at a satellite, but may also refer to such gNB devices which may be provided at an airplane or at a maritime vessel such as a boat, and correspondingly support required RNL protocols.

Some examples for a scenario comprising at least one moveable network entity provided at a satellite are described in specification the 3rd Generation Partnership Project (3GPP) TR 22.865. For instance, a use case for data exchange based on a store and forward concept—Mobile Oriented and/or Mobile Originated (MO), or a use case on store and forward—Mobile Terminated (MT) may be considered as example scenarios.

Example embodiments described in the present disclosure are nevertheless not limited to such example scenarios or example communication systems, although at least some of the terminology used therein is also used for the present description for better legibility.

In the above-cited examples, a store and forward (S&F) service for data exchange, i.e. data delivery and/or reception, between a user equipment with satellite access and an application server in e.g. a delay-tolerant/non-real-time (such as “internet-of-things” (IoT))-non-terrestrial network (NTN) is considered.

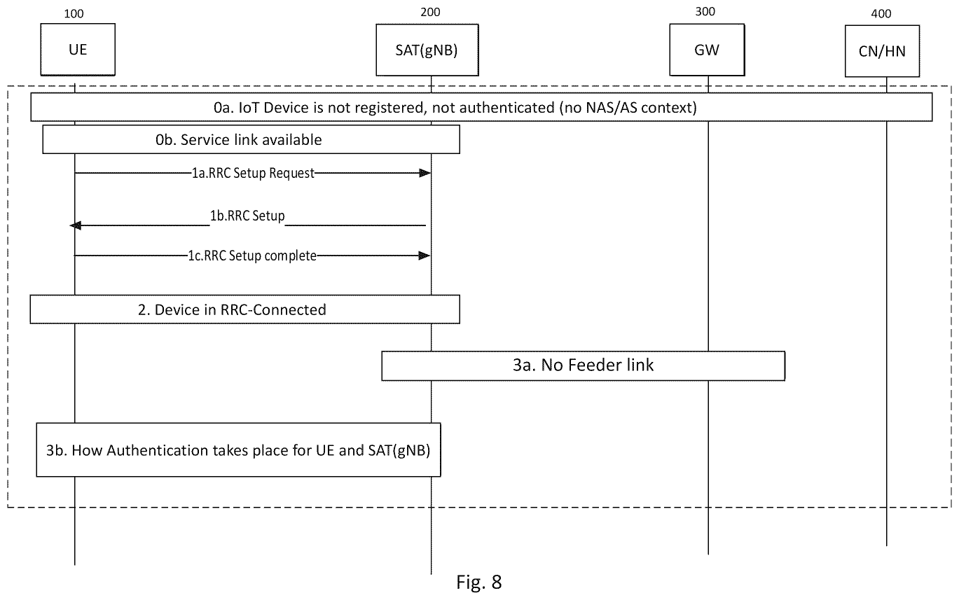

One example of a connection establishment between a movable network entity and a terminal entity, such as a user equipment (UE) is shown in FIG. 8. In such scenarios, typically a base station or gNB provided on a satellite (in some example embodiments referred to as SAT(gNB) 200) may have a communication link via a gateway (GW) to an entity of a core-network (CN) or a home-network (HN). In some example embodiments, the link between the movable network entity and the entity of the core-network or home-network may be referred to as a feeder link. Throughout some example embodiments, it may simply be referred to as a core-network. However, the core-network may also be replaced (or represented) by a home-network. Furthermore, a link between the movable network entity and a terminal such as a UE may be referred to as a service link.

In an example related to NTN, comprising a base station or gNB provided on a satellite (SAT(gNB) 200), the satellite may move into coverage of the UE (or vice versa, i.e. the terminal UE and the mobile entity SAT(gNB) are within or moved to be within each others' coverage). In such a scenario it is also conceivable that the satellite does temporarily not have access, i.e. not have an available link to the core-network. That is, the feeder link may be unavailable when a corresponding base station or gNB on the satellite and the UE establish a connection. In some embodiments, the connection between the corresponding base station or gNB on the satellite and the UE may be referred to as Radio Resource Control (RRC) connection and/or as service link. In this regard, RRC connection and service link may be used synonymously for a communication link or connection between a UE and a base station or next generation NodeB, such as a gNB.

In known communication networks, establishing a (RRC) connection is typically followed by authenticating the UE and/or the base station or gNB using an entity in the core-network. However, if no feeder link, i.e. no connection between the core-network and the base station (gNB) is available, authentication of the UE and/or the base station using or based on an entity in the core-network is not possible. Thus, after establishing an RRC connection, the UE and the base station, gNB, may communicate with each other, but no trusted (authenticated) connection or communication link is available between them.

In above-described example communication systems, as mentioned, links between different apparatuses and/or between an apparatus and a core-network may become (temporarily) unavailable, mainly due to the base station or gNB being provided at a movable and/or moving entity such as a satellite or the like. That is, no end-to-end connection between a terminal entity and an entity in the core-network (which may include an application functionality in the core network) may be available in various scenarios.

Hence, there is a need to improve such scenarios, and to provide for authentication even without end-to-end connection between a terminal entity and an entity in the core-network being available.

### SUMMARY

Various example embodiments aim at addressing at least part of the above issues and/or problems and drawbacks.

Hence, at least some embodiments disclosed herein do address this issue. Some example embodiments enable and/or realize authentication between a movable network entity and a terminal entity, and are described/disclosed below. According to at least some embodiments, the authentication may be considered as a local authentication, because no core-network entity is (directly) involved and/or because during authentication, no connection to an core-network entity is required.

Various aspects of example embodiments are set out in the appended claims.

According to an exemplary aspect, there is provided a method, comprising: in a scenario, in which a movable network entity (200) has an established link to a core-network entity (400) but no established link to a terminal entity (100), and in which the movable network entity moves into a coverage area of the terminal entity allowing establishment of a link between the movable network entity and the terminal entity, obtaining, at the movable network entity, at least a security parameter of the terminal entity, establishing a connection between the terminal entity and the movable network entity based on the security parameter of the terminal entity in response to receiving a connection setup request comprising the security parameter of the terminal entity, and identifying the terminal entity based on a comparison of the security parameter of the terminal entity received in the establishing of the connection and the obtained security parameter of the terminal entity.

According to at least some example embodiments, the security parameter of the terminal entity is an identifier of the terminal entity.

According to at least some example embodiments, the obtaining further comprises obtaining a shared key.

According to at least some example embodiments, the obtained shared key was generated using a key derivation function based on at least a shared secret.

According to at least some example embodiments, the obtained shared key was generated using the key derivation function based on a counter value, the value of which being dependent on a number of connection establishments between the terminal entity and the or another movable network entity, and the shared secret.

According to at least some example embodiments, the identifying of the terminal entity is further based on the shared key.

According to at least some example embodiments, there is further provided receiving, at the movable network entity, data from the terminal entity, and decrypting the received data using the obtained shared key.

According to at least some example embodiments, there is further provided buffering the decrypted data and forwarding the decrypted data to an application via the link to the core-network entity (400) upon said link to the core-network entity (400) being established.

According to at least some example embodiments, the obtaining further comprises obtaining a plurality of non-allocated terminal security parameters, and there is further provided sending one terminal security parameter out of the plurality of non-allocated terminal security parameters to the terminal entity upon decryption of the received data using the shared key, and optionally encrypting the terminal security parameter sent to the terminal using the shared key.

According to at least some example embodiments, there is further provided sending a certificate of the movable network entity from the movable network entity to the terminal entity in response to the connection between the terminal entity and the movable network entity being established.

According to at least some example embodiments, there is provided method, comprising: in a scenario, in which a movable network entity (200) has an established link to a core-network entity (400) but no established link to a terminal entity (100), and in which the movable network entity moves into a coverage area of the terminal entity allowing establishment of a link between the movable network entity and the terminal entity, obtaining a security parameter of the terminal entity, providing, to the movable network entity, at least the security parameter of the terminal entity upon the movable network entity moving into a coverage area of the terminal entity.

According to at least some example embodiments, the providing further comprises obtaining a shared key, and providing the shared key to the movable network entity.

According to at least some example embodiments, the shared key is generated using a key derivation function based on at least the shared secret.

According to at least some example embodiments, the method further comprises incrementing a counter value in response to a connection between the movable network entity and the terminal entity being established, and generating the shared key using the key derivation function based on the counter value and the shared secret.

According to at least some example embodiments, the method further comprises receiving data.

According to at least some example embodiments, the providing further comprises providing a plurality of non-allocated terminal security parameters.

According to at least some example embodiments, there is provided a method, comprising: in a scenario, in which a terminal entity (100) has no established link to a movable network entity (200), which is moving into the coverage area of the terminal entity allowing establishment of a link between the movable network entity and the terminal entity, and in which the terminal entity has a security parameter, sending a connection setup request from the terminal entity to the movable network entity comprising the security parameter, and establishing of a connection between the terminal entity and the movable network entity based on the security parameter.

According to at least some example embodiments, the method further comprises obtaining a shared secret, and generating a shared key using a key derivation function based on at least the shared secret.

According to at least some example embodiments, the method further comprises incrementing a counter value in response to a connection between the movable network entity and the terminal entity being established, and the generating of the shared key using the key derivation function is based on the counter value and the shared secret.

According to at least some example embodiments, the method further comprises encrypting data using the shared key, and sending the encrypted data to the movable network entity.

According to at least some example embodiments, the method further comprises receiving from the movable network entity a further security parameter and buffering the received security parameter.

According to at least some example embodiments, the method further comprises obtaining at least one of a root certificate issued from a certificate authority and a path, and verifying the received certificate of the movable network entity using at least one of the root certificate issued from the certificate authority and the path.

According to at least some example embodiments, there is provided a method, comprising: in a scenario, in which a terminal entity (100) has an established link to a movable network entity (200), and in which the terminal entity is provided with its own certificate and information for validating other certificates, transmitting a registration request to the movable network entity comprising its own certificate and an indication indicative of support for authentication with a moveable network entity, receiving, as a response to the registration request, an authentication request from the movable network entity comprising a certificate of the moveable network entity, and verifying the received certificate of the moveable network entity based on the provided information for validating other certificates.

According to at least some example embodiments, the terminal entity is further provided with its own asymmetric key pair comprising a public key and a private key, and the method further comprises generating an authentifier by encrypting its own public key using its own private key, and transmitting the authentifier to the movable network entity.

According to at least some example embodiments, the received authentication request further comprises a public key of the movable network entity, the method further comprises encrypting data using the received public key of the movable network entity, and the transmitting further comprises transmitting the encrypted data to the movable network entity.

According to at least some example embodiments, there is provided a method, comprising in a scenario, in which a movable network entity (200) has no established link to a core-network entity (400) and an established link to a terminal entity (100), and in which the moveable network entity is provided with its own certificate and information for validating other certificates, transmitting an authentication request to the terminal entity in response to receiving a registration request from the terminal entity comprising a first certificate and an indication indicative of support for authentication with a moveable network entity, the authentication request comprises at least its own certificate, and verifying the received certificate of the moveable network entity based on the provided information for validating other certificates.

According to at least some example embodiments, the method further comprises receiving an authentication response comprising an authentifier, buffering the received authentifier and the first certificate, and forwarding the buffered authentifier and the buffered first certificate to the core-network entity (400) upon said link to the core-network entity (200) being established.

According to at least some example embodiments, the moveable network entity is further provided with its own asymmetric key pair comprising a private key and a public key, and the transmitted authentication request further comprises its own public key, the received authentication response further comprises data, the method further comprises decrypting the received data using its own private key and buffering the decrypted data, and the forwarding further comprises forwarding the decrypted data to the core-network entity (400) upon said link to the core-network entity (400) being established.

According to at least some example embodiments, there is provided a method, comprising in a scenario, in which the core network entity (400) is provided with information for validating certificates, receiving, from a movable network entity (200), via a gateway (300) a message comprising a certificate of a terminal entity (100) and an authentifier, verifying the certificate of the terminal entity, wherein a successful verification comprises obtaining a public key of the terminal entity, decrypting the authentifier with the obtained public key of the terminal entity, and comparing the decrypted authentifier with the obtained public key of the terminal entity.

According to at least some example embodiments, the received message further comprises data, and the method further comprises forwarding the data to an application in response to a scenario wherein the decrypted authentifier and the obtained public key of the terminal entity match when comparing the decrypted authentifier with the obtained public key of the terminal entity.

According to at least some example embodiments, the movable network entity is a non-terrestrial network entity provided on one of a satellite or an airplane or at a maritime vessel.

According to at least some example embodiments, there is provided an apparatus, comprising at least one processor (210), at least one memory (220) including computer program code, and at least one interface (230) configured for communication with at least another apparatus, wherein in a scenario, in which a movable network entity (200) has an established link to a core-network entity (400) but no established link to a terminal entity (100), and in which the movable network entity moves into a coverage area of the terminal entity allowing establishment of a link between the movable network entity and the terminal entity, the at least one processor, with the at least one memory and the computer program code and with the at least one interface is configured to cause the apparatus to perform obtaining, at the movable network entity, of at least a security parameter of the terminal entity, establishing of a connection between the terminal entity and the movable network entity based on the security parameter of the terminal entity in response to receiving a connection setup request comprising the security parameter of the terminal entity, and identifying of the terminal entity based on a comparison of the security parameter of the terminal entity received in the establishing of the connection and the obtained security parameter of the terminal entity.

According to at least some example embodiments, the at least one processor, with the at least one memory and the computer program code and with the at least one interface is configured to cause the apparatus to further perform obtaining of a shared key.

According to at least some example embodiments, the obtained shared key was generated using a key derivation function based on at least a shared secret.

According to at least some example embodiments, the obtained shared key was generated using the key derivation function based on a counter value, the value of which being dependent on a number of connection establishments between the terminal entity and the or another movable network entity, and the shared secret.

According to at least some example embodiments, the identifying of the terminal entity is further based on the shared key.

According to at least some example embodiments, the at least one processor, with the at least one memory and the computer program code and with the at least one interface is configured to cause the apparatus to further perform receiving, at the movable network entity, of data from the terminal entity, and decrypting of the received data using the obtained shared key.

According to at least some example embodiments, the at least one processor, with the at least one memory and the computer program code and with the at least one interface is configured to cause the apparatus to further perform buffering of the decrypted data and forwarding the decrypted data to an application via the link to the core-network entity (400) upon said link to the core-network entity (400) being established.

According to at least some example embodiments, the at least one processor, with the at least one memory and the computer program code and with the at least one interface is configured to cause the apparatus to further perform obtaining of a plurality of non-allocated terminal security parameters, and sending of one terminal security parameter out of the plurality of non-allocated terminal security parameters to the terminal entity upon decryption of the received data using the shared key, and optionally encrypting of the terminal security parameter sent to the terminal using the shared key.

According to at least some example embodiments, the at least one processor, with the at least one memory and the computer program code and with the at least one interface is configured to cause the apparatus to further perform sending of a certificate of the movable network entity from the movable network entity to the terminal entity in response to the connection between the terminal entity and the movable network entity being established.

According to at least some example embodiments, there is provided an apparatus, comprising at least one processor (410), at least one memory (420) including computer program code, and at least one interface (430) configured for communication with at least another apparatus, wherein in a scenario, in which a movable network entity (200) has an established link to a core-network entity (400) but no established link to a terminal entity (100), and in which the movable network entity moves into a coverage area of the terminal entity allowing establishment of a link between the movable network entity and the terminal entity, the at least one processor, with the at least one memory and the computer program code, and with the at least one interface is configured to cause the apparatus to perform obtaining of a security parameter of the terminal entity, providing, to the movable network entity, of at least the security parameter of the terminal entity upon the movable network entity moving into a coverage area of the terminal entity.

According to at least some example embodiments, the at least one processor, with the at least one memory and the computer program code and with the at least one interface is configured to cause the apparatus to further perform obtaining of a shared key, and providing of the shared key to the movable network entity.

According to at least some example embodiments, the shared key is generated using a key derivation function is based on at least the shared secret.

According to at least some example embodiments, the at least one processor, with the at least one memory and the computer program code and with the at least one interface is configured to cause the apparatus to further perform incrementing of a counter value in response to a connection between the movable network entity and the terminal entity being established, and generating of the shared key using the key derivation function based on the counter value and the shared secret.

According to at least some example embodiments, the at least one processor, with the at least one memory and the computer program code and with the at least one interface is configured to cause the apparatus to further perform receiving of data.

According to at least some example embodiments, the at least one processor, with the at least one memory and the computer program code and with the at least one interface is configured to cause the apparatus to further perform providing a plurality of non-allocated terminal security parameters to the movable network entity.

According to at least some example embodiments, there is provided an apparatus, comprising at least one processor (110), at least one memory (120) including computer program code, and at least one interface (130) configured for communication with at least another apparatus, wherein in a scenario, in which a terminal entity (100) has no established link to a movable network entity (200), which is moving into the coverage area of the terminal entity allowing establishment of a link between the movable network entity and the terminal entity, and in which the terminal entity has an security parameter, the at least one processor, with the at least one memory and the computer program code, and with the at least one interface is configured to cause the apparatus to perform sending of a connection setup request from the terminal entity to the movable network entity comprising the security parameter, and establishing of a connection between the terminal entity and the movable network entity based on the security parameter.

According to at least some example embodiments, the at least one processor, with the at least one memory and the computer program code and with the at least one interface is configured to cause the apparatus to further perform obtaining a shared secret, and generating a shared key using a key derivation function based on at least the shared secret.

According to at least some example embodiments, the at least one processor, with the at least one memory and the computer program code and with the at least one interface is configured to cause the apparatus to further perform incrementing a counter value in response to a connection between the movable network entity and the terminal entity being established, and the generating of the shared key using the key derivation function is based on the counter value and the shared secret.

According to at least some example embodiments, the at least one processor, with the at least one memory and the computer program code and with the at least one interface is configured to cause the apparatus to further perform encrypting data using the shared key, and sending the encrypted data to the movable network entity.

According to at least some example embodiments, the at least one processor, with the at least one memory and the computer program code and with the at least one interface is configured to cause the apparatus to further perform receiving of a further security parameter and buffering the received security parameter from the movable network entity.

According to at least some example embodiments, the at least one processor, with the at least one memory and the computer program code and with the at least one interface is configured to cause the apparatus to further perform obtaining at least one of a root certificate issued from a certificate authority and a path, and verifying the received certificate of the movable network entity using at least one of the root certificate issued from the certificate authority and the path.

According to at least some example embodiments, there is provided an apparatus, comprising at least one processor (110), at least one memory (120) including computer program code, and at least one interface (130) configured for communication with at least another apparatus, wherein in a scenario, in which a terminal entity (100) has an established link to a movable network entity (200) and in which the terminal entity is provided with its own certificate and information for validating other certificates, the at least one processor, with the at least one memory and the computer program code, and with the at least one interface is configured to cause the apparatus to perform transmitting of a registration request to the movable network entity comprising its own certificate and an indication indicative of support for authentication with a moveable network entity, receiving, as a response to the registration request, of an authentication request from the movable network entity comprising a certificate of the moveable network entity, and verifying of the received certificate of the moveable network entity based on the provided information for validating other certificates.

According to at least some example embodiments, the terminal entity is further provided with its own asymmetric key pair comprising a public key and a private key, and the at least one processor, with the at least one memory and the computer program code and with the at least one interface is configured to cause the apparatus to further perform generating of an authentifier by encrypting its own public key using its own private key, and transmitting of the authentifier to the movable network entity.

According to at least some example embodiments, the received authentication request further comprises a public key of the movable network entity, and the at least one processor, with the at least one memory and the computer program code and with the at least one interface is configured to cause the apparatus to further perform encrypting of data using the received public key of the movable network entity, and transmitting the encrypted data to the movable network entity.

According to at least some example embodiments, there is provided an apparatus, comprising at least one processor (210), at least one memory (220) including computer program code, and at least one interface (230) configured for communication with at least another apparatus, wherein in a scenario, in which a movable network entity (200) has no established link to a core-network entity (400) and an established link to a terminal entity (100), and in which the moveable network entity is provided with its own certificate and information for validating other certificates, the at least one processor, with the at least one memory and the computer program code, and with the at least one interface is configured to cause the apparatus to perform transmitting of an authentication request to the terminal entity in response to receiving a registration request from the terminal entity comprising a first certificate and an indication indicative of support for authentication with a moveable network entity, the authentication request comprises at least its own certificate, and verifying of the received certificate of the moveable network entity based on the provided information for validating other certificates.

According to at least some example embodiments, the at least one processor, with the at least one memory and the computer program code and with the at least one interface is configured to cause the apparatus to further perform receiving an authentication response comprising an authentifier, buffering the received authentifier and the first certificate, and forwarding the buffered authentifier and the buffered first certificate to the core-network entity (400) upon said link to the core-network entity (200) being established.

According to at least some example embodiments, the moveable network entity is further provided with its own asymmetric key pair comprising a private key and a public key, the transmitted authentication request further comprises its own public key, the received authentication response further comprises data, and the at least one processor, with the at least one memory and the computer program code and with the at least one interface is configured to cause the apparatus to further perform decrypting of the received data using its own private key and buffering the decrypted data, and forwarding the decrypted data to the core-network entity (400) upon said link to the core-network entity (400) being established.

According to at least some example embodiments, there is provided an apparatus, comprising at least one processor (410), at least one memory (420) including computer program code, and at least one interface (430) configured for communication with at least another apparatus, wherein in a scenario, in which the core network entity (400) is provided with information for validating certificates, the at least one processor, with the at least one memory and the computer program code, and with the at least one interface is configured to cause the apparatus to perform receiving, from a movable network entity (200), via a gateway (300) of a message comprising a certificate of a terminal entity (100) and an authentifier, verifying of the certificate of the terminal entity, wherein a successful verification comprises obtaining a public key of the terminal entity, decrypting of the authentifier with the obtained public key of the terminal entity, and comparing of the decrypted authentifier with the obtained public key of the terminal entity.

According to at least some example embodiments, the received message further comprises data, and the at least one processor, with the at least one memory and the computer program code and with the at least one interface is configured to cause the apparatus to further perform forwarding of the data to an application in response to a scenario wherein the decrypted authentifier and the obtained public key of the terminal entity match when comparing the decrypted authentifier with the obtained public key of the terminal entity.

According to at least some example embodiments, the movable network entity is a non-terrestrial network entity provided on one of a satellite or an airplane or at a maritime vessel.

According to at least some example embodiments, there is provided a computer program product comprising computer-executable computer program code, which when the program is run on a computer, is configured to cause the computer to carry out any of the disclosed methods.

According to at least some example embodiments, the computer program product comprises a non-transitory computer-readable medium on which the computer-executable computer program code is stored, and/or wherein the program is directly loadable into an internal memory of the computer or a processor thereof.

Any one of the above aspects enables (local) authentication without end-to-end connection between a terminal entity and an entity in the core-network, to thereby solve at least part of the problems and drawbacks identified in relation to the prior art.

By way of example embodiments, there are provided methods, apparatuses and computer program code, which are configured and/or adapted to provide (local) authentication without end-to-end connection between a terminal entity and an entity in the core-network. More specifically, by way of example embodiments, there are provided measures and mechanisms for realizing (local) authentication, and/or mutual authentication of involved entities and/or apparatuses.

By virtue of at least some of the above embodiments, one or more of the following advantages can be obtained:
authentication of a terminal entity such as a user equipment despite (temporarily) unavailable communication links and/or unavailable end-to-end connection between a terminal entity and an entity in the core-network;
authentication of movable network entities despite (temporarily) unavailable communication links and/or unavailable end-to-end connection between a terminal entity and an entity in the core-network;
identification of a terminal entity such as a user equipment despite (temporarily) unavailable communication links and/or unavailable end-to-end connection between a terminal entity and an entity in the core-network;
establishing a trusted and/or authenticated RRC connection between a terminal entity and a movable network entity despite (temporarily) unavailable end-to-end connection between the terminal entity and an entity in the core-network;
integrity checks of data exchanged despite (temporarily) unavailable communication links and/or unavailable end-to-end connection between a terminal entity and an entity in the core-network;
generating shared keys for use in at least some scenarios for authentication despite (temporarily) unavailable communication links and/or unavailable end-to-end connection;
securely exchanging, i.e. forwarding and/or receiving data despite (temporarily) unavailable communication links and/or unavailable end-to-end connection between a terminal entity and an entity in the core-network based on a store and forward (S&F) architecture or concept that may be deployed in e.g. a NTN scenario or others.

### BRIEF DESCRIPTION OF THE DRAWINGS

In the following, the present disclosure will be described in greater detail by way of non-limiting examples with reference to the accompanying drawings, in which

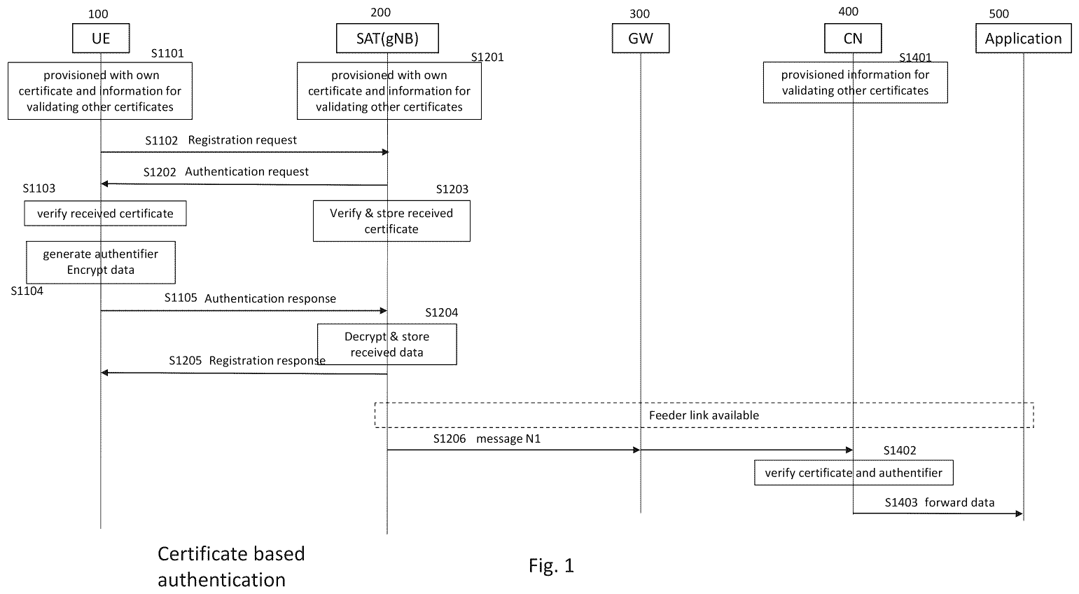

In FIG. 1, a signaling sequence of an exemplary mechanism for local authentication between a terminal entity and a movable network entity is illustrated.

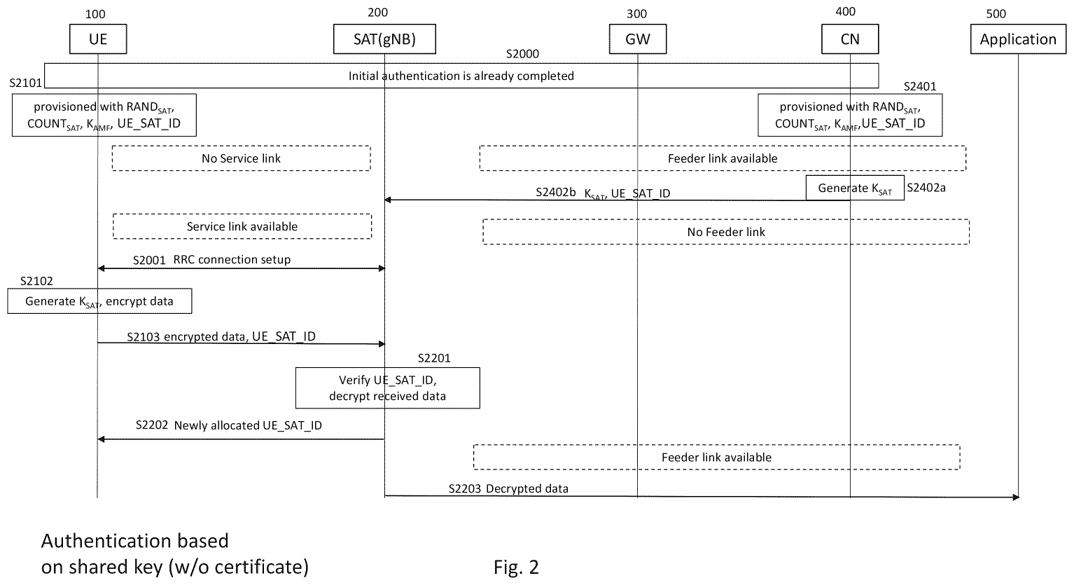

In FIG. 2, a signaling sequence of another exemplary mechanism for local authentication between a terminal entity and a movable network entity is illustrated.

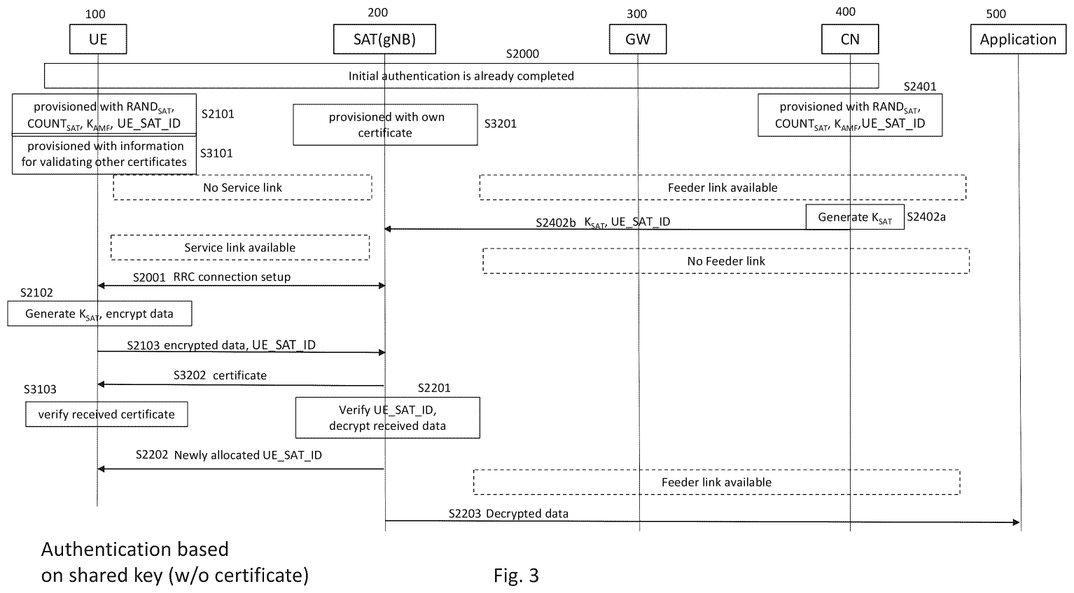

In FIG. 3, a signaling sequence of still another exemplary mechanism for local authentication between a terminal entity and a movable network entity is illustrated.

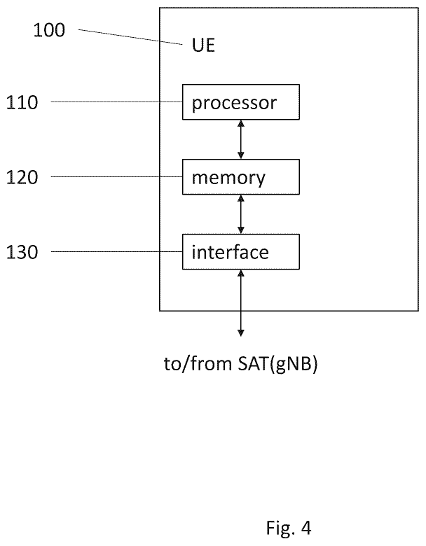

In FIG. 4, an alternative illustration of terminal apparatuses, e.g. of a user equipment UE, according to example embodiments is depicted.

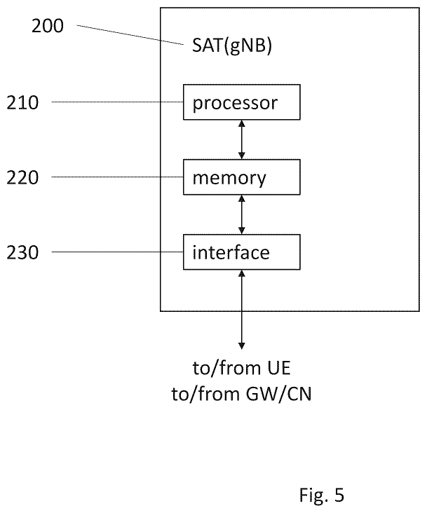

In FIG. 5, an alternative illustration of movable entity apparatuses, e.g. a SAT(gNB) according to example embodiments is depicted.

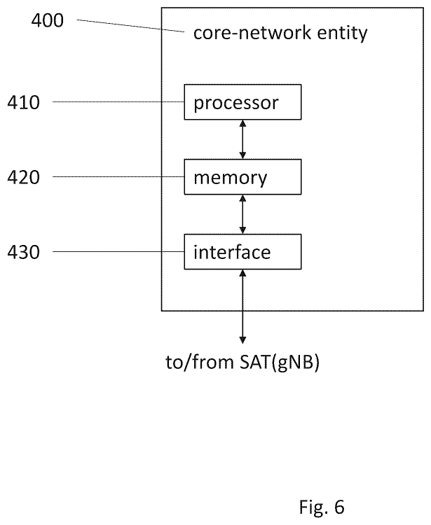

In FIG. 6, an alternative illustration of core network entity apparatuses, e.g. a CN entity according to example embodiments is depicted.

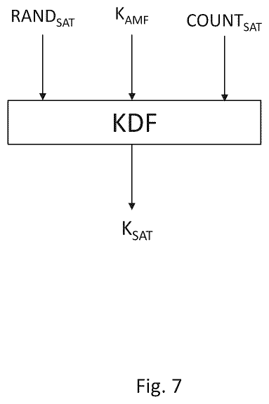

In FIG. 7, a block diagram illustrating inputs and outputs of a key derivation functionality (KDF) (which may be implemented as program code or as hardwired circuitry or module) according to at least some example embodiments is shown.

In FIG. 8, an example of a connection establishment mentioned in the introductory portion is illustrated.

### DETAILED DESCRIPTION

The present disclosure is described herein with reference to particular non-limiting examples and to what is presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology, which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also comprising combinations of individual features of the various variants and/or alternatives).

As used herein, “at least one of the following: <a list of two or more elements >” and “at least one of <a list of two or more elements>” and similar wording, where the list of two or more elements are joined by “and” or “or”, mean at least any one of the elements, or at least any two or more of the elements, or at least all the elements.

Furthermore, a computer program comprising instructions may be provided, which when executed by an apparatus, cause the apparatus to perform each method step. Said instructions may also be stored on a non-transitory computer readable medium. The term “non-transitory,” as used herein, is a limitation of the medium itself (i.e., tangible, not a signal) as opposed to a limitation on data storage persistency (e.g., Random Access Memory (RAM) vs. Read Only Memory (ROM)).

As used in this application, the term “obtaining respective data” may refer to one of the following:
a) receiving without performing generation of the respective data within a respective entity and
b) fetching the respective data from a connected entity, such as a server, and
c) generating the respective data within a respective entity. In this context, obtaining a respective item or data may also refer to loading or fetching a previously stored item or data. Any of receiving, fetching, generating may be triggered by an internal or external event and/or condition, such as e.g. receiving a message or a program calls or an instruction of a program stored in at least one memory and executed by at least one processor.

According to example embodiments, in general terms, there are provided corresponding methods and apparatuses for enabling/realizing (local) authentication, which are described herein below.

### First Embodiment

FIG. 1 illustrates a first embodiment of a mechanism for (local) authentication between a terminal entity such as a User Equipment (UE) and a movable network entity. In FIG. 1, a signaling sequence of an exemplary mechanism comprising methods and corresponding apparatuses for performing (local) authentication between apparatuses like the terminal entity, such as the UE, and the movable network entity is illustrated.

In at least some example embodiments, such as in the first embodiment, a satellite as deployed in non-terrestrial networks, NTN, may be referred to as an example of a moveable network entity. In at least some examples the mobile network entity may thus be referred to as SAT(gNB). However, the SAT(gNB) only represents an example and the present disclosure is not limited thereto. Rather, the present disclosure may also be applicable to communication systems, wherein a moveable network entity may be represented by devices, which may be provided at an airplane or at a maritime vessel such as a boat, and correspondingly support respective RNL protocols deployed and/or required in such scenarios.

Furthermore, some example embodiments generally may relate to a store and forward (S&F) architecture or concept that may be deployed in e.g. a NTN scenario or others. An S&F architecture is attributable to situations in which the feeder link (between the movable network entity and the core network (entity/entities) and/or the gateway connecting the core-network with the movable network entity may temporarily be unavailable. Store and forward in the sense of this disclosure only relates the capability of storing received data and forwarding the stored data later.

Even though, in some example embodiments it is referred to user equipment and/or IoT devices, the corresponding mechanisms are applicable to any kind of user equipment (UE), basically every equipment that can establish a connection to the moveable network entity, and which can send and/or receive data, e.g. phones, cars, IoT devices, robots or any other UE devices with cellular protocol stack support. Such devices and other examples corresponding to the UE may also be referred to as a terminal entity.

For the methods and apparatuses illustrated in FIG. 1, no previous authentication and no end-to-end connection between the terminal entity and an entity in the core-network (which may include an application functionality in the core network) is required. That is, the mechanism described in this example embodiment is applicable to any scenario, wherein a moveable network entity, such as a base station or next generation NodeB, gNB, provided on the satellite, which may be referred to as SAT(gNB) 200 for example, moves into coverage of another entity, such as the UE, 100. Even though the present disclosure and at least some example embodiments are applicable to any kind of terminal entity that can establish a connection to the moveable network entity, in at least some example embodiments, it will be referred to the terminal entity as UE 100 for simplicity. As described above, at least some example embodiments are applicable for any kind of moveable network entity, i.e. any devices, which may be provided at an airplane or at a maritime vessel such as a boat, and correspondingly support required RNL protocols. Nonetheless, the moveable network entity may be referred to as SAT(gNB) 200 for descriptive reasons and simplicity in an example communication system in line with a non-terrestrial network. However, this does not limit example embodiments to such SAT(gNB) 200 and as described above, example embodiments comprising such SAT(gNB) 200 are nevertheless not limited to non-terrestrial networks although at least some of the terminology used therein is also used for the present description for better legibility.

Throughout the Figures, entities involved in the signaling are illustrated and denoted as blocks 100 (UE), 200 (SAT/gNB), 300 (gateway GW), 400 (Core network CN entity), and 500 (application functionality). Signals exchanged therebetween are denoted by labeled arrows S* illustrated in horizontal direction. Processing performed by a respective entity are illustrated as a box in vertical direction below the respective entity. The sequence of processing is typically (but not always necessarily) represented in vertical direction of the drawing. Boxes in dashed lines indicate circumstances or conditions if certain links or connections are generally available or not.

In general, both as well as only one of the UE 100 and the SAT(gNB) 200 may be pre-provisioned with an own certificate that was previously issued by a certificate authority (CA) as respectively illustrated in steps S1101 and S1201 of FIG. 1. Likewise, both as well as only one of the UE 100 and the SAT(gNB) 200 may also pre-provisioned with a root CA certificate as information for validating other certificates as respectively illustrated in steps S1101 and S1201 of FIG. 1, too. The root CA certificate may include or be provided with a corresponding root path as the information for validating other certificates. The information for validating other certificates may also be referred to as a Trust chain. In at least some example embodiments, corresponding certificates and/or the information for validating other certificates may be provided via/from a public CA or via/from a local CA, which may be any known CA.

Furthermore, both the UE 100 and the SAT(gNB) 200 may be pre-provisioned with an own asymmetric key pair comprising a public key and a private key, respectively (but omitted from the illustration in e.g. S1101 and/or S1201).

After an RRC connection between the UE 100 and the SAT(gNB) 200 is established, i.e. an untrusted connection is available, in step S1102 of FIG. 1, the UE 100 sends a registration request to the SAT(gNB) 200 according to the example sequencing diagram illustrated in FIG. 1. The registration request comprises an indication indicative of support for (local) authentication with a moveable network entity. Such indication could be included in at least one of an existing field of an existing header or in a new field of an existing header or in a new header. Furthermore, the registration request comprises the UE's own certificate. However, given that the connection is not secured or trusted at this point, preferably no security parameters are included in the registration request.

Upon receiving the registration request (S1102) with the indication indicative of support for (local) authentication with a moveable network entity, responsive thereto the SAT(gNB) 200 sends an authentication request to the UE 100, wherein this authentication request according to some example embodiments such as the first embodiment comprises the own certificate of the SAT(gNB) 200 (S1202).

Within this authentication request S1202, the SAT(gNB) 200 may also share, i.e. send its public key to the UE 100. Alternatively, the SAT(gNB) 200 may also share its public key based on or via other mechanisms or messages independent of the authentication request.

After receiving the respective messages (registration request (S1102) and authentication request (S1202)), according to at least the first example embodiment, both the UE 100 and the SAT(gNB) 200 validate the respective received certificate using the information for validating other certificates in steps S1103 and S1203, respectively. In this regard, the SAT(gNB) 200 also stores the UE's certificate in a memory (S1203).

In at least the example according to the first example embodiment, the UE 100 and the SAT(gNB) 200 are both pre-provisioned with an own certificate and the information for validating other certificates as described with respect to steps S1101 and S1201. The corresponding transmission and verification of the certificates, with which the UE 100 and the SAT(gNB) 200 are pre-provisioned, allows for mutual authentication.

Alternatively, only one of the UE 100 and the SAT(gNB) 200 may be pre-provisioned with an own certificate and the other one of the UE 100 and the SAT(gNB) 200 may be pre-provisioned with the information for validating other certificates. This would still allow at least one-sided authentication.

After verifying the certificate of the SAT(gNB) 200 in step S1103, in step S1104, the UE 100 uses the public key of the SAT(gNB) 200 to encrypt data, such as a message comprising payload, which is to be sent to an application or any other entity in the core-network or in a home network. The kind of data or its origin does not matter for example embodiments and authentication methods described herein. Just as an example, in case the terminal UE is a IoT terminal, the message/payload may contain measurement data of a sensor provided at the terminal, which measurement result is wirelessly reported.

Additionally, the UE 100 generates an authentifier in step S1104 by applying its own private key to its public key. That is, the authentifier is the UE's public key after it is encrypted using the UE's private key to encrypt the UE's public key.

In step S1105, the UE 100 sends a message comprising the generated authentifier and the encrypted (payload) data to the SAT(gNB) 200. The message comprising the generated authentifier and the encrypted data may also be referred to as an authentication response.

Upon receiving the authentication response, the SAT(gNB) 200 decrypts the received data using its own private key and stores or respectively buffers the decrypted data in a memory (not shown here) in step S1204. Furthermore, the SAT(gNB) 200 also stores the received authentifier in step S1204.

Additionally, in step S1205, the SAT(gNB) 200 sends a registration response after validating the UE's certificate in step S1203.

At some point, a connection between the SAT(gNB) 200 and the core-network, also referred to as feeder link, will become available (again). When the feeder link is available, the SAT(gNB) 200 still has the authentifier, the decrypted data and the UE's certificate stored in memory.

When the feeder link to the core-network, e.g. via a gateway GW 300 is available (again), the SAT(gNB) 200 sends a message N1 comprising the authentifier, the decrypted data and the UE's certificate to an entity in the core-network 400 via the GW 300 in step S1206. Sending the message N1 may also be referred to as sending a registration request or as forwarding a received registration request.

Also, the entity in the core-network 400 is pre-provisioned with information for validating other certificates (S1401). For instance, the entity in the core-network 400 may be pre-provisioned with a root CA certificate and/or a corresponding root path.

Subsequently, the entity in the core-network 400 according to at least the first example embodiment will validate the UE's certificate received within the message N1 using the information for validating other certificates in step S1402. If the verification of the UE's certificate is successful, the entity in the core-network 400 may also obtain the UE's public key using the information for validating other certificates as an expected public key of the UE. If the verification of the UE's certificate is not successful, the corresponding registration request is not accepted and/or deleted.

Furthermore, if the verification of the UE's certificate is successful, the entity in the core-network 400 decrypts the received authentifier using the obtained public key, i.e. the expected public key of the UE in step S1402. The decrypted authentifier is subsequently compared to the expected public key of the UE in step S1402 and if the decrypted authentifier and the expected public key of the UE match, the UE is successfully authenticated. The reason is that the entity in the core-network 400 implicitly verifies the proof of possession in that the UE 100 generating the authentifier needs to own the private key corresponding to the public key of the UE obtained when verifying the successfully verified certificate.

In at least some example embodiments, the entity in the core-network 400 may be an Access and Mobility Management Function (AMF) but alternatively, the entity in the core-network 400 may also be any other entity in/of the core-network that is capable of verifying the UE's certificate and forwarding the data to a corresponding application. For instance, the entity in the core-network 400 may also be an entity, which is communicatively connected to the AMF via the core-network.

If the decrypted authentifier and the expected public key of the UE match, i.e. if the UE is successfully authenticated, in step S1403, the entity in the core-network 400 also forwards the data received from the SAT(gNB) 200 to a corresponding target application, which may be located in or connected to the core-network or a home network.

By virtue of at least some of the methods and corresponding apparatuses for performing (local) authentication between apparatuses as described with respect to FIG. 1, it is possible to perform initial (local) authentication as well as mutual authentication between a user equipment and a moveable network entity despite (temporary) unavailability of end-to-end connections between the terminal entity and an entity in the core-network. Furthermore, a final authentication may be performed in the core-network. As described above, also integrity checks of exchanged data may be performed in at least the first example embodiment.

This way, it is possible to send data from a user equipment via a moveable network entity to an application in the core-network or in a home-network via secure and trusted connections, without requiring an end-to-end connection between the terminal entity such as the user equipment and an entity or application in the core-network or a home-network via a moveable network entity like the SAT(gNB) 200.

In this regard, the person skilled in the art also understands that in a store and forward service or architecture, for data exchange, i.e. data delivery and/or reception, as described in the first example embodiment with respect to FIG. 1, no end-to-end connections between the terminal entity and an entity the core-network (which may include an application functionality in the core network) is required to securely transmit data from the terminal entity to an entity or an application in the core-network.

### Second Embodiment

FIG. 2 illustrates a second embodiment of a mechanism for (local) authentication between a terminal entity such as a User Equipment (UE) as an example and a movable network entity. In FIG. 2, a signaling sequence of an exemplary mechanism comprising methods and corresponding apparatuses for performing (local) authentication between apparatuses like the terminal entity, such as the UE, and the movable network entity is illustrated according to the second embodiment.

In at least some example communication systems involving at least one movable network entity, such as a base station or a next generation NodeB, gNB, e.g. a base station or gNB in a non-terrestrial network, which may be referred to as SAT(gNB) 200 for example, it may occur that a terminal entity such as a user equipment (UE) and the moveable network entity may be disconnected after an initial authentication between the UE and the moveable network entity or an entity in the core-network (CN) 400 was already completed.

In at least some example embodiments, such as in the second embodiment, a satellite as deployed in non-terrestrial networks, NTN, may be referred to as an example of a moveable network entity. However, the present disclosure is not limited thereto. Rather, the present disclosure may also be applicable to communication systems, wherein a moveable network entity may be represented by devices, which may be provided at an airplane or at a maritime vessel such as a boat, and correspondingly support required RNL protocols.

Furthermore, some example embodiments generally may relate to a store and forward (S&F) service and/or architecture, for data exchange, i.e. data delivery and/or reception, that may be deployed in e.g. a NTN scenario or others. An S&F architecture is attributable to situations in which the feeder link (between the movable network entity and the core network (entity/entities) and/or the gateway connecting the core-network with the movable network entity may temporarily be unavailable.

Even though, in some example embodiments, it is referred to user equipment and/or IoT devices as example devices, the corresponding mechanisms are applicable to any kind of user equipment (UE) and basically every equipment that can establish connection to the moveable network entity, and which can send and/or receive data, e.g. phones, cars, IoT devices, robots or any other UE devices with cellular protocol stack support. Such devices and other examples of corresponding to the UE may also be referred to as a terminal entity.

As described above, at least some example embodiments are applicable for any kind of moveable network entity, i.e. any devices, which may be provided at an airplane or at a maritime vessel such as a boat, and correspondingly support required RNL protocols. Nonetheless, the moveable network entity may be referred to as SAT(gNB) 200 for descriptive reasons and simplicity in an example communication system in line with a non-terrestrial network. However, this does not limit example embodiments to such SAT(gNB) 200 and as described above, example embodiments comprising such SAT(gNB) 200 are nevertheless not limited to non-terrestrial networks although at least some of the terminology used therein is also used for the present description for better legibility.

Throughout the Figures, entities involved in the signaling are illustrated and denoted as blocks 100 (UE), 200 (SAT(gNB)), 300 (gateway GW), 400 (Core network CN entity), and 500 (application functionality). Signals exchanged therebetween processing steps are denoted by labeled arrows S* illustrated in horizontal direction. Processing performed by a respective entity are illustrated as a box in vertical direction below the respective entity. The sequence of processing is typically (but not always necessarily) represented in vertical direction of the drawing. Boxes in dashed lines indicate circumstances or conditions if certain links or connections are generally available or not.

For re-authentication after an initial authentication between the UE and the entity in the core-network (CN) 400, it can be assumed, as illustrated in steps S2101 and S2401 of FIG. 2, that both the UE and the entity in the core-network 400 are provisioned with a shared secret RAND_{SAT}, a counter value COUNT_{SAT}, which is described later, and a key K_{AMF}, which were established or respectively shared in a previous and/or initial authentication. The key K_{AMF} may be generated within an initial authentication, e.g. based on functionalities of an Access and Mobility Management Function (AMF). The derivation or generation of the key K_{AMF} may be according to any known generation method, e.g. as defined in 3GPP TS 33.501 version 15.4.0 Release 15, but may also be replaced by any other shared key generation or derivation.

Moreover, it can be assumed for re-authentication after an initial authentication between the UE 100 and the entity in the core-network (CN) 400 as also illustrated in steps S2101 and S2401 of FIG. 2, that the UE 100 is provisioned with a security parameter as a security parameter of the terminal entity like for example an identifier (UE_SAT_ID) as an identifier of the terminal entity or a password or some other code or a signature, of which also the entity in the core-network 400 is aware. Even though the identifier and the password are only examples for a security parameter, in some embodiments it may simply be referred to identifier and/or identifier of the terminal entity for liability. However, it is to be understood that the present disclosure is not limited to such identifier and also other security parameters may be applied. That is, the identifier (UE_SAT_ID) was assigned or respectively allocated to the UE 100 within or after a previous authentication and/or previous connection establishment between the terminal entity and a movable network entity and the entity in the core-network 400 knows the identifier (UE_SAT_ID) or may obtain it from e.g. an AMF. Furthermore, the entity in the core-network 400 has stored or may obtain from another entity a plurality of identifiers of terminal entities that are not allocated to any UE or terminal entity at the corresponding time. The UE_SAT_ID, the shared secret RAND_{SAT}, and the counter value COUNT_{SAT} are assigned during initial authentication in a secured way. For instance, the UE_SAT_ID, the shared secret RAND_{SAT}, the counter value COUNT_{SAT} may be assigned during initial authentication in Non-Access-Stratum, NAS, security mode procedures.

In at least some example embodiments such as the second embodiment, a mechanism for (local) authentication between a terminal entity, i.e. the UE 100 and a movable network entity, i.e. the SAT(gNB) 200 is provided. In FIG. 2, a sequence of an exemplary mechanism for (local) authentication between the terminal entity and the movable network entity according to the second embodiment is illustrated. In the second embodiment it is also assumed that it may be foreseen or expected when a moveable network entity moves into coverage of a UE or a terminal entity, which was already authenticated at the core-network but is temporarily not connected to a moveable network entity, such as the SAT(gNB) 200. This may happen at any time when a connection, i.e. a communication link between the SAT(gNB) 200 and the core-network is available but no connection, i.e. communication link between the moveable network entity, e.g. the SAT(gNB) 200 and the UE 100, also referred to as feeder link, is available. At this time, before the connection between the SAT(gNB) 200 and the core-network may be lost due to movement of the moveable network entity, the entity in the core-network 400 according to at least some example embodiments such as the second embodiment provides the SAT(gNB) 200 with a shared key K_{SAT} in step S2402b of FIG. 2. The shared key K_{SAT} may be generated by using the shared secret RAND_{SAT}, the counter value COUNT_{SAT}, which is described later, and the key K_{AMF} as inputs for a key derivation function, KDF (S2402a). A block diagram illustrating inputs (RAND_{SAT}, COUNT_{SAT}, and K_{AMF}) and outputs (the shared key K_{SAT}) of the KDF is shown in FIG. 7. In this regard, any known or new KDF may be used, such as KDFs used for key derivations e.g. in 3GPP TS 33.501 version 15.4.0 Release 15, but also other known or new key derivation functions may be used.

After generating the shared key K_{SAT} in step S2402a, the entity in the core-network 400 sends the generated shared key K_{SAT} to the mobile network entity SAT(gNB) 200 in step S2402b. Additionally, the entity in the core-network 400 also sends the identifier (UE_SAT_ID) of the UE 100 to the SAT(gNB) 200 in step S2402b.

When the SAT(gNB) 200 moves into coverage of the UE 100 (or alternatively if the UE 100 moves into coverage of the SAT(gNB) 200), a Radio Resource Control, RRC, connection, i.e. a communication link also referred to as service link, between the SAT(gNB) 200 and the UE 100 becomes available and may be established in step S2001.

In response to (re-)connecting to the SAT(gNB) 200 or to any other moveable network entity, e.g. a moveable base station or next generation NodeB, gNB, that is, after the RRC connection between the SAT(gNB) 200 and the UE 100 is established, the UE 100 increments the previously mentioned counter value COUNT_{SAT} by one in step S2102. During an initial authentication between the UE 100 and an entity in the core-network, the counter value COUNT_{SAT} is initialized to zero and is incremented by one for every connection establishment between the UE 100 and a moveable network entity, which connects the UE 100 to the core-network or stores and forwards data from the UE 100 to the core-network.

Accordingly, also the entity in the core-network 400, which is provisioned with the shared secret RAND_{SAT}, the counter value COUNT_{SAT}, and the key K_{AMF}, keeps track of connection establishments between the UE 100 and any moveable network entity. For instance, this may happen in that the entity in the core-network 400 generates and provides the shared key K_{SAT} to the moveable network entity, for which the counter value COUNT_{SAT} is used as an input. Before generating the shared key K_{SAT} for establishing a connection between the UE 100 and a moveable network entity, the entity in the core-network 400 also increments the counter value by one.

Similar to the entity in the core-network 400, the UE 100 generates the shared key K_{SAT} in step S2102 by using the shared secret RAND_{SAT}, the counter value COUNT_{SAT}, and the key K_{AMF} as inputs for a key derivation function, KDF, as illustrated in FIG. 7. As mentioned with respect to the key generation performed by the entity in the core-network 400, any known or new KDF may be used, such as KDFs used for key derivations e.g. in 3GPP TS 33.501 version 15.4.0 Release 15, but also other known or new key derivation functions may be used.

This way, the UE 100 and the entity in the core-network 400 will always use an updated but synchronized counter value COUNT_{SAT} as an input for the KDF during key generation of the shared key K_{SAT} (S2102, S2402), such that for every connection establishment between the UE 100 and a moveable network entity such as the SAT(gNB) 200, a new shared key K_{SAT} is generated. Hence, it is possible to always rely on a secure symmetric key for communication between a moveable network entity and a terminal entity.

After generating the new shared key K_{SAT}, the UE 100 encrypts data, such as a message, which is to be sent to an application or any other entity in the core-network or in a home network, using the generated key K_{SAT} in step S2102. The kind of data or its origin does not matter for example embodiments and authentication methods described herein. Just as an example, in case the terminal UE is a IoT terminal, the message/payload may contain measurement data of a sensor provided at the terminal, which measurement result is wirelessly reported.

Afterwards, the UE 100 sends its security parameter such as the identifier (UE_SAT_ID) and the encrypted data to the SAT(gNB) 200 in S2103. In at least some example embodiments such as the second embodiment, the UE 100 may send its security parameter or identifier (UE_SAT_ID) and the encrypted data within one message to the SAT(gNB) 200. However, the UE 100 may alternatively send its security parameter and the encrypted data in two separate messages to the SAT(gNB) 200. For instance, the UE 100 may also send the encrypted data to the SAT(gNB) 200 after at least one of an authentication procedure and an identification procedure is finished.

After receiving the security parameter such as the identifier UE_SAT_ID from the UE 100, the SAT(gNB) 200 may identify and thereby also authenticate the UE 100. In some example embodiments relying for instance on the identifier UE_SAT_ID as the security parameter, identification and authentication may be performed by comparing the identifier UE_SAT_ID received from the UE 100 with the identifier UE_SAT_ID of the terminal entity received from the entity in the core-network 400 in step S2201.

If the identifier UE_SAT_ID received from the UE 100 and the identifier UE_SAT_ID of the terminal entity received from the entity in the core-network 400 match, the UE 100 is authenticated and integrity is also implicitly verified. That is, the message cannot be tampered or manipulated if the respective identifier UE_SAT_ID, which was only known to the UE 100 in addition to the core-network 400 and the SAT(gNB) 200 after receiving the identifier UE_SAT_ID from the entity in the core-network 400, is received at the SAT(gNB) 200.

The SAT(gNB) 200, upon valid authentication and/or integrity verification, decrypts the received data and forwards it to the entity in the core-network 400 or an application in the core-network or an application in a home-network via a gateway (GW) when a connection to the core-network, i.e. a so-called feeder link, is available again in step S2203.

In some example embodiments, e.g. in addition to the above described mechanism according to the second embodiment, when the entity in the core-network 400 sends the shared key K_{SAT} and the identifier (UE_SAT_ID) of the UE 100 to the SAT(gNB) 200 in step S2402, the entity in the core-network 400 may also send a plurality of identifiers, which are not allocated to any UE or terminal entity at the corresponding time, to the SAT(gNB) 200 in S2402. Then after the SAT(gNB) 200 successfully performed an authentication and/or an integrity verification of the UE 100, the SAT(gNB) 200 allocates and sends an identifier (UE_SAT_ID) of the plurality of identifiers, which are not allocated to any UE or terminal entity at the corresponding time, to the UE 100 in step S2202. The SAT(gNB) 200 will also report the new allocation of the identifier (UE_SAT_ID) to the UE 100 to the entity in the core-network 400, when a link between the SAT(gNB) 200 and the core-network is available again, for instance in step S2203. This way, the newly allocated identifier (UE_SAT_ID) may be used for authentication in a later connection between the UE 100 and the SAT(gNB) 200 or any other moveable network entity.

In this example embodiment, a mechanism for one connection establishment between one UE 100 and one SAT(gNB) 200 is described. However, it is evident to the person skilled in the art that a terminal entity like the UE 100 may establish several connections after another to different movable network entities like the SAT(gNB) 200, e.g. because several moveable network entities move into and out of coverage of the UE 100, one after another (or vice versa, i.e. the terminal UE and the mobile entity SAT(gNB) are within or moved to be within each others' coverage). In this scenario, the described mechanism and/or methods according to the second embodiment may repeated for every connection establishment. Likewise, it is also evident to the person skilled in the art that a moveable network entity, such as the SAT(gNB) 200, may connect to multiple terminal entities, both in parallel or sequentially.

By virtue of at least some methods and apparatuses disclosed with respect to FIG. 2 in the second example embodiment, it is possible to perform (local) identification and authentication between a user equipment and a moveable network entity despite (temporary) unavailability of end-to-end connections between the terminal entity and an entity in the core-network (which may include an application functionality in the core network). As described above, also integrity checks of exchanged data may be performed in at least the second example embodiment.

Furthermore, at least some methods and apparatuses disclosed with respect to FIG. 2 in the second example embodiment allow to send data from a user equipment via a moveable network entity to an application in the core-network or in a home-network via secure and trusted connections, without requiring an end-to-end connection between the terminal entity such as the user equipment and an entity or application in the core-network or a home-network via a moveable network entity like the SAT(gNB) 200.

In this regard, the person skilled in the art also understands that in a store and forward service and/or architecture, for data exchange, i.e. data delivery and/or reception, as described in the second example embodiment with respect to FIG. 2, no end-to-end connections between the terminal entity and an entity the core-network (which may include an application functionality in the core network) is required to securely transmit data from the terminal entity to an entity or an application in the core-network.

### Third Embodiment

FIG. 3 illustrates a third embodiment of a mechanism for (local) authentication between a terminal entity such as a User Equipment (UE) as an example and a movable network entity. In FIG. 3, a signaling sequence of an exemplary mechanism comprising methods and corresponding apparatuses for performing (local) authentication between apparatuses like the terminal entity, such as the UE, and the movable network entity is illustrated.

In at least some example communication systems involving at least one movable network entity, such as a base station or next generation NodeB, gNB, e.g. a base station or gNB in a non-terrestrial network, which may be referred to as SAT(gNB) 200 for example, it may occur that a terminal entity such as a user equipment (UE) and the moveable network entity may be disconnected after an initial authentication between the UE and the moveable network entity or an entity in the core-network (CN) 400 was already completed.

In at least some example embodiments, such as in the third embodiment, a satellite as deployed in non-terrestrial networks, NTN, may be referred to as an example of a moveable network entity. However, the present disclosure is not limited thereto. Rather, the present disclosure may also be applicable to communication systems, wherein a moveable network entity may be represented by devices, which may be provided at an airplane or at a maritime vessel such as a boat, and correspondingly support required RNL protocols.

Furthermore, some example embodiments generally may relate to a store and forward (S&F) service and/or architecture, for data exchange, i.e. data delivery and/or reception, that may be deployed in e.g. a NTN scenario or others. An S&F architecture is attributable to situations in which the feeder link (between the movable network entity and the core network (entity/entities) and/or the gateway connecting the core-network with the movable network entity may temporarily be unavailable.

Even though, in some example embodiments it is referred to user equipment and/or IoT devices, the corresponding mechanisms are applicable to any kind of user equipment (UE), basically every equipment that can establish a connection to the moveable network entity, and which can send and/or receive data, e.g. phones, cars, IoT devices, robots or any other UE devices with cellular protocol stack support. Such devices and other examples corresponding to the UE may also be referred to as a terminal entity.

As described above, at least some example embodiments are applicable for any kind of moveable network entity, i.e. any devices, which may be provided at an airplane or at a maritime vessel such as a boat, and correspondingly support required RNL protocols. Nonetheless, the moveable network entity may be referred to as SAT(gNB) 200 for descriptive reasons and simplicity in an example communication system in line with a non-terrestrial network.

However, this does not limit example embodiments to such SAT(gNB) 200 and as described above, example embodiments comprising such SAT(gNB) 200 are nevertheless not limited to non-terrestrial networks although at least some of the terminology used therein is also used for the present description for better legibility.

Throughout the Figures, entities involved in the signaling are illustrated and denoted as blocks 100 (UE), 200 (SAT(gNB)), 300 (gateway GW), 400 (Core network CN entity), and 500 (application functionality). Signals exchanged therebetween processing steps are denoted by labeled arrows S* illustrated in horizontal direction. Processing performed by a respective entity are illustrated as a box in vertical direction below the respective entity. The sequence of processing is typically (but not always necessarily) represented in vertical direction of the drawing. Boxes in dashed lines indicate circumstances or conditions if certain links or connections are generally available or not.

In systems involving at least one movable network entity, such as a base station or next generation NodeB, or gNB, e.g. a base station or gNB in non-terrestrial network, which may be referred to as SAT(gNB) 200 for example, it may occur that a terminal entity such as a user equipment (UE) and the moveable network entity may be disconnected after an initial authentication between the UE and the moveable network entity or an entity in the core-network (CN) 400 was already completed.

In the third embodiment, a mechanism for (local) authentication between a User Equipment (UE) and a movable network entity is provided. In FIG. 3, a sequence of an exemplary mechanism for (local) authentication between the terminal entity, e.g. the UE 100 and the movable network entity, e.g. the SAT(gNB) 200 according to the third embodiment is illustrated.

The third embodiment comprises the mechanism, i.e. apparatuses and methods as described in the second embodiment with respect to FIG. 2. Hence, a description of elements and steps already described with respect to FIG. 2 in the second embodiment is omitted.

Additionally, the SAT(gNB) 200 according to the third embodiment is pre-provisioned with an own certificate that was previously issued by a certificate authority (CA), as illustrated in step S3201 of FIG. 3. Correspondingly, the UE 100 according to the third embodiment is pre-provisioned with a root CA certificate and/or with a corresponding root path as the information for validating other certificates, as illustrated in step S3101 of FIG. 3. The information for validating other certificates may also be referred to as a Trust chain.

When a connection between the UE 100 and the SAT(gNB) 200 is established, the SAT(gNB) 200 also sends its own certificate to the UE 100 in step S3202 of FIG. 3. Upon receiving the certificate of the SAT(gNB) 200, the UE verifies the received certificate using the information for validating other certificates in step S3102 of FIG. 3.

By virtue of at least some methods and apparatuses disclosed with respect to FIG. 3 in the third example embodiment, it is possible to perform (local) identification and authentication as well as mutual authentication, between a user equipment and a moveable network entity despite (temporary) unavailability of end-to-end connections between the terminal entity and an entity in the core-network (which may include an application functionality in the core network). As described above, also integrity checks of exchanged data may be performed in at least the third example embodiment.

This way, it is possible to send data from a user equipment via a moveable network entity to an application in the core-network or in a home-network via secure and trusted connections, without requiring an end-to-end connection between the terminal entity such as the user equipment and an entity or application in the core-network or a home-network via a moveable network entity like the SAT(gNB) 200.

In this regard, the person skilled in the art also understands that in a store and forward service and/or architecture, for data exchange, i.e. data delivery and/or reception, as described in the third example embodiment with respect to FIG. 3, no end-to-end connections between the terminal entity and an entity the core-network (which may include an application functionality in the core network) is required to securely transmit data from the terminal entity to an entity or an application in the core-network.

### Other Embodiments

The above-described procedures and functions may be implemented by respective functional elements, processors, or the like, as described below.

In FIG. 4, an alternative illustration of apparatuses according to example embodiments is depicted. As indicated in FIG. 4, according to example embodiments, the terminal entity such as the UE 100 comprises a processor 110, a memory 120 and an interface 130, which may be connected via direct connections, by a bus, or the like.

Furthermore, in FIG. 5, an alternative illustration of apparatuses according to example embodiments is depicted. As illustrated in FIG. 5, the moveable network entity, such as the SAT(gNB) 200, comprises a processor 210, a memory 220, a interface 230, which may be connected via direct connections, by a bus, or the like.

In FIG. 6, an alternative illustration of apparatuses according to example embodiments is depicted. As illustrated in FIG. 6, an entity in the core-network 400 comprises a processor 410, a memory 420 and an interface 430, which may be connected via direct connections, by a bus, or the like. Optionally, the entity in the core-network 400 may further comprises a modem to facilitate sending and receiving data.

A Gateway 300 (not illustrated) may comprise a processor, a memory, a receiver and a sender, or alternatively a router or a modem to forward data and messages between the core-network and movable network entities.

Any of the processors 110, 210 and 410 and/or the interfaces 130, 230 and 430 may also comprise a modem or the like to facilitate communication over a (hardwire or wireless) link, respectively. The interfaces 130, 230 and 430 may comprise a suitable transceiver coupled to one or more antennas or communication means for (hardwire or wireless) communications with the linked or connected device(s), respectively. The interfaces 130, 230 and 430 are generally configured to communicate with at least one other apparatus, i.e. the interface thereof.

The memories 120, 220 and 420 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”). Alternatively, such function is to be construed to be equivalently implementable by units specifically configured to perform the respective function (i.e., the expression “processor configured to [cause the apparatus to] perform xxx-ing” is construed to be equivalent to an expression such as “xxx unit configured to xxx”).

According to at least some example embodiments, an apparatus representing the UE 100 comprises at least one processor 110, at least one memory 120 and at least one interface 130 configured for communication with at least another apparatus. In a scenario, in which a terminal entity has no established link to a movable network entity, which is moving into the coverage area of the terminal entity allowing establishment of a link between the movable network entity and the terminal entity, and in which the terminal entity has a security parameter, the processor (i.e. the at least one processor 110, with the at least one memory 120 and the computer program code and with the at least one interface 130) is configured to perform sending of a connection setup request from the terminal entity to the movable network entity comprising the security parameter (thus the apparatus comprising corresponding means for sending a connection setup request from the terminal entity to the movable network entity comprising the security parameter), and to perform establishing of a connection between the terminal entity and the movable network entity based on the security parameter (thus the apparatus comprising corresponding means for establishing of a connection between the terminal entity and the movable network entity based on the security parameter).

According to at least some example embodiments, an apparatus representing the SAT(gNB) 200 comprises at least one processor 210, at least one memory 220 and at least one interface 230 configured for communication with at least another apparatus. In a scenario, in which a movable network entity has an established link to a core-network entity but no established link to a terminal entity, and in which the movable network entity moves into a coverage area of the terminal entity allowing establishment of a link between the movable network entity and the terminal entity, the processor (i.e. the at least one processor 210, with the at least one memory 220 and the computer program code and with and with the at least one interface 230) is configured to perform obtaining, at the movable network entity, of at least a security parameter of the terminal entity (thus the apparatus comprising corresponding means for obtaining, at the movable network entity, at least a security parameter of the terminal entity), to perform establishing of a connection between the terminal entity and the movable network entity based on the security parameter of the terminal entity in response to receiving a connection setup request comprising the security parameter of the terminal entity (thus the apparatus comprising corresponding means for establishing a connection between the terminal entity and the movable network entity based on the security parameter of the terminal entity in response to receiving a connection setup request comprising the security parameter of the terminal entity), and to perform identifying of the terminal entity based on a comparison of the security parameter of the terminal entity received in the establishing of the connection and the obtained security parameter of the terminal entity (thus the apparatus comprising corresponding means for identifying the terminal entity based on a comparison of the security parameter of the terminal entity received in the establishing of the connection and the obtained security parameter of the terminal entity).

According to at least some example embodiments, an apparatus representing the entity in the core-network 400 comprises at least one processor 410, at least one memory 420 and at least one interface 430 configured for communication with at least another apparatus. In a scenario, in which a movable network entity has an established link to a core-network entity but no established link to a terminal entity, and in which the movable network entity moves into a coverage area of the terminal entity allowing establishment of a link between the movable network entity and the terminal entity, the processor (i.e. the at least one processor 410, with the at least one memory 420 and the computer program code) is configured to perform obtaining of a security parameter of the terminal entity (thus the apparatus comprising corresponding means for obtaining a security parameter of the terminal entity), and to perform providing, to the movable network entity, of at least the security parameter of the terminal entity upon the movable network entity moving into a coverage area of the terminal entity (thus the apparatus comprising corresponding means for providing, to the movable network entity, at least the security parameter of the terminal entity upon the movable network entity moving into a coverage area of the terminal entity).

According to at least some example embodiments, an apparatus representing the UE 100 comprises at least one processor 110, at least one memory 120 and at least one interface 130 configured for communication with at least another apparatus. In a scenario, in which a terminal entity has an established link to a movable network entity, and in which the terminal entity is provided with its own certificate and information for validating other certificates, the processor (i.e. the at least one processor 110, with the at least one memory 120 and the computer program code and with the at least one interface 130) is configured to perform transmitting of a registration request to the movable network entity comprising its own certificate and an indication indicative of support for authentication with a moveable network entity (thus the apparatus comprising corresponding means for transmitting a registration request to the movable network entity comprising its own certificate and an indication indicative of support for authentication with a moveable network entity), to perform receiving, as a response to the registration request, of an authentication request from the movable network entity comprising a certificate of the moveable network entity (thus the apparatus comprising corresponding means for receiving, as a response to the registration request, an authentication request from the movable network entity comprising a certificate of the moveable network entity) and to perform verifying of the received certificate of the moveable network entity based on the provided information for validating other certificates (thus the apparatus comprising corresponding means verifying the received certificate of the moveable network entity based on the provided information for validating other certificates).

According to at least some example embodiments, an apparatus representing the SAT(gNB) 200 comprises at least one processor 210, at least one memory 220 and at least one interface 230 configured for communication with at least another apparatus. In a scenario, in which a movable network entity has no established link to a core-network entity and an established link to a terminal entity, and in which the moveable network entity is provided with its own certificate and information for validating other certificates, the processor (i.e. the at least one processor 210, with the at least one memory 220 and the computer program code and with and with the at least one interface 230) is configured to perform transmitting of an authentication request to the terminal entity in response to receiving a registration request from the terminal entity comprising a first certificate and an indication indicative of support for authentication with a moveable network entity, wherein the authentication request comprises at least its own certificate (thus the apparatus comprising corresponding means for transmitting an authentication request to the terminal entity in response to receiving a registration request from the terminal entity comprising a first certificate and an indication indicative of support for authentication with a moveable network entity, wherein the authentication request comprises at least its own certificate), and to perform verifying of the received certificate of the moveable network entity based on the provided information for validating other certificates (thus the apparatus comprising corresponding means for verifying the received certificate of the moveable network entity based on the provided information for validating other certificates).

According to at least some example embodiments, an apparatus representing the entity in the core-network 400 comprises at least one processor 410, at least one memory 420 and at least one interface 430 configured for communication with at least another apparatus. In a scenario, in which the core network entity is provided with information for validating certificates, the processor (i.e. the at least one processor 410, with the at least one memory 420 and the computer program code) is configured to perform receiving, from a movable network entity, via a gateway of a message comprising a certificate of a terminal entity and an authentifier (thus the apparatus comprising corresponding means for receiving, from a movable network entity, via a gateway a message comprising a certificate of a terminal entity and an authentifier), to perform verifying of the certificate of the terminal entity, wherein a successful verification comprises obtaining a public key of the terminal entity (thus the apparatus comprising means for verifying the certificate of the terminal entity, wherein a successful verification comprises obtaining a public key of the terminal entity), to perform decrypting of the authentifier with the obtained public key of the terminal entity (thus the apparatus comprising means for decrypting the authentifier with the obtained public key of the terminal entity), and to perform comparing of the decrypted authentifier with the obtained public key of the terminal entity (thus the apparatus comprising corresponding means for comparing the decrypted authentifier with the obtained public key of the terminal entity).

Furthermore, it is to be understood that when it is stated that the processor (or some other means) is configured to perform some function, such function is to be construed to be equivalently implementable by specifically configured circuitry (i.e. the expression “processor configured to [cause the apparatus to] perform xxx-ing” is construed to be equivalent to an expression such as “xxx-circuitry configured to perform xxx-ing”).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (comprising digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, comprising in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

For further details regarding the operability/functionality of the individual apparatuses, reference is made to the above description in connection with any one of FIGS. 1 to 6, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities comprising apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
an apparatus like the terminal entity and the moveable network entity may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
an entity may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

There are provided methods, apparatuses and computer program products for authentication between a movable network entity and a terminal entity. Such provided methods, apparatuses and computer program products may include authentication and/or identification based on sending and/or receiving at least one security parameter and/or at least one authentifier.

### LIST OF ACRONYMS AND ABBREVIATIONS

3GPP 3rd Generation Partnership Program
5GC 5G Core
5G GUTI 5G Globally Unique Temporary Identifier
AMF Access and Mobility Management Function
AS Access Stratum
CA Certificate Authority
CN Core Network
gNB Next Generation NodeB/5G Node B
GW Gateway
HN Home Network
IoT Internet of Things
ISL Inter Satellite Link
KDF Key Derivation Function
MO Mobile Oriented
MT Mobile Terminated
NAS Non-Access-Stratum
NTN Non-Terrestrial Network
RAN Radio Access Network
RNL Radio Network Layer
RRC Radio Resource Control
SAT Satellite
S&F Store and Forward
UE User Equipment
UPF User Plane Function

1. An apparatus, comprising
at least one processor (210),
at least one memory (220) including computer program code, and
at least one interface (230) configured for communication with at least another apparatus, wherein
in a scenario, in which
a movable network entity (200) has an established link to a core-network entity (400) but no established link to a terminal entity (100), and in which
the movable network entity moves into a coverage area of the terminal entity allowing establishment of a link between the movable network entity and the terminal entity,
the at least one processor, with the at least one memory and the computer program code and with the at least one interface is configured to cause the apparatus to perform:
obtaining, at the movable network entity, of at least a security parameter of the terminal entity,
establishing of a connection between the terminal entity and the movable network entity based on the security parameter of the terminal entity in response to receiving a connection setup request comprising the security parameter of the terminal entity, and
identifying of the terminal entity based on a comparison of the security parameter of the terminal entity received in the establishing of the connection and the obtained security parameter of the terminal entity.

2. The apparatus according to claim 1, wherein
the at least one processor, with the at least one memory and the computer program code and with the at least one interface is configured to cause the apparatus to further perform obtaining of a shared key.

3. The apparatus according to claim 2, wherein the obtained shared key was generated using a key derivation function based on at least a shared secret.

4. The apparatus according to claim 3, wherein
the obtained shared key was generated using the key derivation function based on a counter value, the value of which being dependent on a number of connection establishments between the terminal entity and the or another movable network entity, and the shared secret.

5. The apparatus according to claim 2, wherein the identifying of the terminal entity is further based on the shared key.

6. The apparatus according to claim 2, wherein
the at least one processor, with the at least one memory and the computer program code and with the at least one interface is configured to cause the apparatus to further perform
receiving, at the movable network entity, of data from the terminal entity, and
decrypting of the received data using the obtained shared key.

7. The apparatus according to claim 6, wherein
the at least one processor, with the at least one memory and the computer program code and with the at least one interface is configured to cause the apparatus to further perform buffering of the decrypted data and forwarding of the decrypted data to an application via the link to the core-network entity (400) upon said link to the core-network entity (400) being established.

8. The apparatus according to claim 1, wherein
the at least one processor, with the at least one memory and the computer program code and with the at least one interface is configured to cause the apparatus to further perform
obtaining of a plurality of non-allocated terminal security parameters, and
sending of one terminal security parameter out of the plurality of non-allocated terminal security parameters to the terminal entity upon decryption of the received data using the shared key, and
optionally encrypting of the terminal security parameter sent to the terminal using the shared key.

9. The apparatus according to claim 1, wherein
the at least one processor, with the at least one memory and the computer program code and with the at least one interface is configured to cause the apparatus to further perform
sending of a certificate of the movable network entity from the movable network entity to the terminal entity in response to the connection between the terminal entity and the movable network entity being established.

10. An apparatus, comprising
at least one processor (410),
at least one memory (420) including computer program code, and
at least one interface (430) configured for communication with at least another apparatus, wherein
in a scenario, in which
a movable network entity (200) has an established link to a core-network entity (400) but no established link to a terminal entity (100), and in which
the movable network entity moves into a coverage area of the terminal entity allowing establishment of a link between the movable network entity and the terminal entity,
the at least one processor, with the at least one memory and the computer program code, and with the at least one interface is configured to cause the apparatus to perform:
obtaining of a security parameter of the terminal entity,
providing, to the movable network entity, of at least the security parameter of the terminal entity upon the movable network entity moving into a coverage area of the terminal entity.

11. The apparatus according to claim 10, wherein
the at least one processor, with the at least one memory and the computer program code and with the at least one interface is configured to cause the apparatus to further perform
obtaining of a shared key, and
providing of the shared key to the movable network entity.

12. The apparatus according to claim 11, wherein
the at least one processor, with the at least one memory and the computer program code and with the at least one interface is configured to cause the apparatus to further perform generating of the shared key generated using a key derivation function based on at least the shared secret.

13. The apparatus according to claim 12, wherein
the at least one processor, with the at least one memory and the computer program code and with the at least one interface is configured to cause the apparatus to further perform
incrementing of a counter value in response to a connection between the movable network entity and the terminal entity being established, and
generating of the shared key using the key derivation function based on the counter value and the shared secret.

14. The apparatus according to claim 11, wherein
the at least one processor, with the at least one memory and the computer program code and with the at least one interface is configured to cause the apparatus to further perform receiving of data.

15. The apparatus according to claim 11, wherein
the at least one processor, with the at least one memory and the computer program code and with the at least one interface is configured to cause the apparatus to further perform providing a plurality of non-allocated terminal security parameters to the movable network entity.

16. An apparatus, comprising
at least one processor (110),
at least one memory (120) including computer program code, and
at least one interface (130) configured for communication with at least another apparatus, wherein
in a scenario, in which
a terminal entity (100) has no established link to a movable network entity (200), which is moving into the coverage area of the terminal entity allowing establishment of a link between the movable network entity and the terminal entity, and in which
the terminal entity has an security parameter,
the at least one processor, with the at least one memory and the computer program code, and with the at least one interface is configured to cause the apparatus to perform:
sending of a connection setup request from the terminal entity to the movable network entity comprising the security parameter, and
establishing of a connection between the terminal entity and the movable network entity based on the security parameter.

17. The apparatus according to claim 16, wherein
the at least one processor, with the at least one memory and the computer program code and with the at least one interface is configured to cause the apparatus to further perform
obtaining a shared secret, and
generating a shared key using a key derivation function based on at least the shared secret.

18. The apparatus according to claim 17, wherein
the at least one processor, with the at least one memory and the computer program code and with the at least one interface is configured to cause the apparatus to further perform
incrementing a counter value in response to a connection between the movable network entity and the terminal entity being established, and wherein
the generating of the shared key using the key derivation function is based on the counter value and the shared secret.

19. The apparatus according to claim 17, wherein
the at least one processor, with the at least one memory and the computer program code and with the at least one interface is configured to cause the apparatus to further perform
encrypting data using the shared key, and
sending the encrypted data to the movable network entity.

20. The apparatus according to claim 17, wherein
the at least one processor, with the at least one memory and the computer program code and with the at least one interface is configured to cause the apparatus to further perform receiving of a further security parameter and buffering the received security parameter from the movable network entity.
